(19) United States
(12) Patent Application Publication
(10) Pub. No.: US 2024/0188482 A1
(43) Pub. Date: Jun. 13, 2024

(54) Seedball Planting System and Methods of Using Same

(71) Applicant: CAFU APP DMCC, Dubai (AE)

(72) Inventors: Rashid Abdulla Ahmad Al Ghurair, Dubai (AE); Mikhail Alekseevich, Dubai (AE); Anton Sudarev, Abu Dhabi (AE)

(21) Appl. No.: 18/523,026

(22) Filed: Nov. 29, 2023

Related U.S. Application Data
(60) Provisional application No. 63/428,539, filed on Nov. 29, 2022.

(51) Int. Cl. A01C 21/00; A01C 5/06; A01C 7/14; A01C 7/20

(52) U.S. Cl. CPC A01C 21/00; A01C 5/064; A01C 5/066; A01C 7/14; A01C 7/203

(57) ABSTRACT

A system and method are described for planting seedballs into soft soils at a certain depth, in each planting point, using unmanned Ground Vehicle in uninterrupted motion. The system penetrates the soil, deposits seedballs into the soil and cover them after penetration. The system delivers seedballs from a hoper to a planting stinger comprising a tube for seedballs delivery to ground and two moving shovels which create a hole in the soil for depositing a seedball therein and then facilitate covering the hole with the seedball therein with sand. The system is configured to allow accurate planting of seedballs while in continuous uninterrupted motion, at a predetermined depth of the soil, at planting points of the sand having different distances between each other without affecting the area closest to the planting area and free of wheel or track slippage.

### CROSS-REFERENCE TO RELATED APPLICATION

This application is a US non-provisional patent application, which claims priority from U.S. Provisional Patent Application No. 63/428,539, filed on 29 Nov. 2022 and entitled “Seedball Planting System and Method Of Using Same”, the entirety of which is hereby incorporated by reference.

### TECHNICAL FIELD

The present invention relates generally to a distribution assembly for an unmanned ground vehicle, and more particularly to a distribution assembly configured to discharge product from the distribution assembly attached to the moving platform and more particularly to a seedball planting system and methods of using same.

### BACKGROUND

In general, planting of seeds involves a) ploughing the field, that is upturning the soil in predetermined rows to create a depression between the two parallel rows of soil, b) planting the seed either by hand sowing or by using machines to either sow or scatter the seeds/plantlets; and c) closing the soil over the seed so as to avoid its dispersion by wind/water; or being eaten by pests or birds. Depending on the type of plant to be grown, step c) may or may not be carried through. In some cases, instead of sowing seeds, seedballs are used. Seedballs are a compact ball like structure comprising seeds of plant and optionally, a nutrient composition (which may be compost or fertilizer) and optionally, some form of soil/mud/clay to bind all the elements. Seedballs are increasingly gaining popularity in recent years owing to their ease in planting in difficult terrains/soils.

In areas with soft soil, it is difficult to bury the seedballs at a predetermined dept consistently. Specifically in arid region, and in areas with an irrigation system already employed, it is important to plant the seedballs consistently at a predetermined dept and at a precise location so as not to damage the already present irrigation system. There are existing devices for planting seeds and seedballs that allow planting to a certain depth. Also, similar systems are known, where the planting mechanism is connected through a drive system to drive wheels, which theoretically provide planting with a certain equal spacing. Devices are also known in which additional wheels or ploughs affect soil before and after the planting point to loosen the soil before planting or cover the seeds with soil after planting. These systems have several disadvantages, in particular, they do not allow planting with an inconsistent pitch in certain points and can damage the pre-installed irrigation system (in case of using ploughs or other devises that touch the ground near to the planting point). Also, in such machines, when the planting mechanism is mechanically connected to the driving wheels or other moving parts of the machine, it is impossible to accurately plant the seedball at a predetermined point, because when moving on loose soil (sand), the wheels or tracks often slip, which leads to an unstable speed of the moving vehicle before reaching the planting point and directly during planting.

The above describes conventional solutions, where additional parts are used to affect the soil to create furrow at aimed depth, in which seeds are planted, and other tools are used for covering the seeds. In such solutions, when the planting apparatus is driven by wheels or running gear of a vehicle, the positioning of planting apparatus in the planting point becomes difficult due to slippage that could occur during operating the vehicle on the sandy soil. As such, there is a desire in the field for planting systems and methods to overcome at least some of the deficiencies outline above.

### SUMMARY OF THE INVENTION

The current invention has several aspects. In one aspect of the invention, a planting system is described. The planting system includes a stinger configured to create an opening in the ground, deposit a seedball in the farrow and to cover the seedball after its deposit. When reference is made to planting of seedball, it is to be understood that the same system and techniques describe may also be used for planting seeds. The stinger in the planting system includes: a first part comprising a solid hollow channel disposed between a first end and a second end. The first end, the hollow channel and the second end form a path of unobstructed fall movement of the seedball from the first end to the second end. The stinger also includes a second part comprising a pair of shovels, each of the pair of shovels having an arm and a tip, the arms are coupled to one another and to a section of the first part near the second end forming a pivoting point, wherein the arms are pivotally movable about the pivoting point to form one of a closed configuration and an open configuration. In the closed configuration, the tips of the pair of shovels form a complementing shape to cover and block the path of the second end, and in the open configuration, the tips depart from each other to uncover and clear the path of the second end. The complementing shape may be a downward facing conical shape for example. The planting system further includes a rotating platform, to which the stinger is securely coupled and is rotatable in a vertical plane, with the tips of the pair of shovels pointing away from the rotating platform. The stinger is configured to receive the seedball at the first end, rotate the tips in the closed configuration to penetrate the ground and create the opening, switch to the open configuration to deposit the seedball into the opening through the second end and continue rotating to exit the ground and to the cover the deposited seedball with soil from the ground.

In a related embodiment of the planting system, the stinger further comprises biasing means coupled to each arm for maintaining the coupled arms in the closed configuration. The stinger is configured to switch to the open configuration when external pressure is applied to the biasing means. A non-limiting example of biasing means is tension springs.

In a further related embodiment of the planting system, the rotating platform is coupled to a pulley that is rotated through a belt by a motor. The pulley and the motor are fixed to a frame. In such system, rotation movement of the pulley and the stinger are directly related.

In yet a further related embodiment of the planting system, the planting system further comprising a tube having: an end coupled to the first end of the stinger; an opening in the tube for receiving the seedball; and a pusher for sliding inside the tube to push the seedball inside the tube to the first end of the stinger.

In a further related embodiment of the planting system, the planting system further comprising sensors disposed on the frame along the rotating path of the stinger. The sensors are configured to detect the stinger and the motor is configured to control the movement of the stinger based on data received from the sensors. The position and number of sensors may vary among embodiments. Also, different type of sensors may be used.

In a further related embodiment of the planting system, the planting system further comprises a stopper unit disposed on the frame along the path of movement of the stinger, where the stopper is configured to hold the stinger in an idle position based on data obtained from the sensors.

In a further related embodiment of the planting system, the frame is mounted on a vehicle.

In yet a further related embodiment of the planting system, the planting system further comprises a hopper for housing seedballs. The hopper is connected to the receiving end of the tube by a flexible pipe, wherein the flexible pipe is configured to form a channel for the seedballs to fall from the hopper to the receiving end of the tube.

In a further related embodiment of the planting system, the height of the frame is adjustable relative to the vehicle and the height of the frame directly correlates to a ground penetration depth of the stinger.

In a further related embodiment of the planting system the motor comprises a one-way bearing and the rotation of the stinger is locked in one of a clockwise or counterclockwise direction, such that when the tips of the stinger touch the ground and penetrate the soil, movement of the vehicle will cause the stinger to further penetrate the soil and continue rotating in the rotation direction.

In a further related embodiment, when the stinger tips are in contact with the ground, the rotation movement of the stinger is based on forward movement of the vehicle and when the stinger tips are away from the ground, the rotational movement of the stinger is based on the motor.

In another related embodiment of the planting system, each arm of the pair of shovels has a protrusion (slips) on its outer surface and wherein special profile parts are affixed to the bottom of the frame, such that during the rotational movement of the stinger, the stinger is configured to switch to the open configuration when the protrusions connect with and slide on the special profile parts.

In a further related embodiment of the planting system, planting system is configured such that the protrusions connect with and slide on the special profile parts during the rotation movement of the stinger when the tips are in contact with the ground.

In another related embodiment of the planting system, the flexible pipe is a mesh-like structure formed by coupling a plurality of longitudinal wires to the internal circumference of a plurality of links to form a perforated channel. The spaces in such channels are used to allow the debris from the seedball to pass through and fall to the ground.

In another aspect of the invention, a method of using the planting system described above for accurately planting seedballs at predetermined planting locations and at predetermined soil depths, while in continuous motion, free of slippage, is described. The method includes: configuring the planting system such that the mechanical operation of the motor is independent from the mechanical operation of the vehicle; associating the rotational movement of the stinger with the motor, when the tips of the stinger are away from the ground and associating the rotational movement of the stinger with the forward movement of the vehicle, when the tips of the stinger are in contact with the ground; and varying the height of the planting system in relation to the ground based on sensory information obtained about the ground.

In a related embodiment, the method further comprising varying a distance between the predetermined planting locations by holding the stinger in a position away from the ground while moving the vehicle from one predetermined planting location to another predetermined planting location.

In another related embodiment, the hopper is mounted on the vehicle using shock absorbers.

In a further related embodiment, the hopper is equipped with a vibration motor for preventing seedballs from being jammed at a connection point between the hopper and the flexible pipe.

In another aspect of the invention, a method of planting seedballs using the planting system described above is described. The method includes the steps of: (a) holding the stinger in an initial position away from the ground using the stopper unit; (b) moving the vehicle to a desired planting location; (c) rotating the stinger using the motor to the position, where the tips contact the ground; (d) creating an opening in the ground using the stinger in the open configuration; (e) depositing the seedball in the opening; (f) continuing to rotate the stinger using forward movement of the vehicle to cover the seedball and exit the ground; (g) operating the stinger using the motor to return and hold the stinger to the initial position; and (g) repeating steps (b) to (f) until all desired planting locations are completed.

Other aspects and embodiments of the invention will be apparent as will be shown in the detailed description of the invention.

### BRIEF DESCRIPTION OF THE DRAWINGS

The operation of the invention may be better understood by reference to the detailed description taken in connection with the following illustrations. The accompanying drawings illustrate non-limiting example embodiments of the invention.

FIG. 1A shows a perspective view of a planting system, comprising the planting apparatus and distribution assembly coupled to an Unmanned Ground Vehicle (UGV), according to an embodiment of the invention.

FIG. 1B shows a back view of the planting system of FIG. 1A.

FIG. 2 shows a schematic side view of the planting system of FIG. 1A in operation with the dotted lines representing different positions of the stinger at different stages (a, b, c and d) of the operational movement of the system.

FIG. 3 shows a front (left) and back (right) perspective views of the planting apparatus, according to an embodiment of the current invention.

FIG. 4 shows a perspective view of the stinger for planting seedballs in loose soil in a closed (left) and an open (right) configuration.

FIG. 5A shows a schematic side view of the pusher that moves the seedballs from the hopper to the internal volume of the chamber leading to the planting stinger, where the figure shows partially exposed internal sections of the stinger 40, showing the internal arrangement of chamber 50 and channel 181, through which the seedball enters the internal space of the stinger before planting.

FIG. 5B shows a cross-sectional view along line-5-5 of FIG. 5A.

FIG. 6A shows a perspective view of the planting apparatus coupled to the distribution assembly with the stinger arm in the closed configuration before planting a seedball.

FIG. 6B shows a perspective view of the planting apparatus coupled to the distribution assembly with the stinger arm in the open configuration during planting a seedball.

FIG. 6C shows a perspective view of the planting apparatus coupled to the distribution assembly with the stinger arm in the closed configuration after planting a seedball.

FIG. 7 shows a bottom view of the stinger arm at different stages of operation (a, b, c, d and e) over time as stinger 40 rotates, where slips 170 connect with and move at different positions relative to specially formed parts 150, causing the stinger head and base to move between the closed configuration and the open configuration.

FIG. 8A to FIG. 8D show schematic side views of the planting device according to a different embodiment, at different stages of operation over time.

FIG. 9 shows a partial perspective view of the stinger arm according to an embodiment of the invention, where the seedball is released from the stinger's head.

FIG. 10 shows a perspective view of a seedball hopper, according to an embodiment of the invention, connected with the planting apparatus.

FIG. 11A shows perspective view of the pipe design connecting the hopper to the planting apparatus, according to an exemplary embodiment of the invention.

FIG. 11B shows the cross-sectional view of a segment of the connecting pipe between the hopper and the planting apparatus, as shown in FIG. 11A, along line C-C.

### DEATAILED DESCRIPTION

Throughout the following description, specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense. The use of same reference numbers in different instances in the description and figures may indicate similar or identical items.

The current invention relates to agricultural apparatus of the type used for the planting of seedballs (the prepared nutrition ball with the seeds inside). The classic technology of planting nutrition seedballs usually does not involve burying them into soil. The current invention overcomes this deficiency. Specifically, the current invention may be used for planting seedballs in the desert or areas with similar conditions, where for the planting to be proper, the nutrition seedball should be penetrated into the soil (ordinary sand) at certain depth, which is dependent on the type of the plant and the climate in a particular region. The current invention could be used for planting in an area where an irrigation system is already pre-installed, for example drip point irrigation. accordingly, where the use of traditional ploughs or similar devices is unacceptable because such devices may damage the irrigation system.

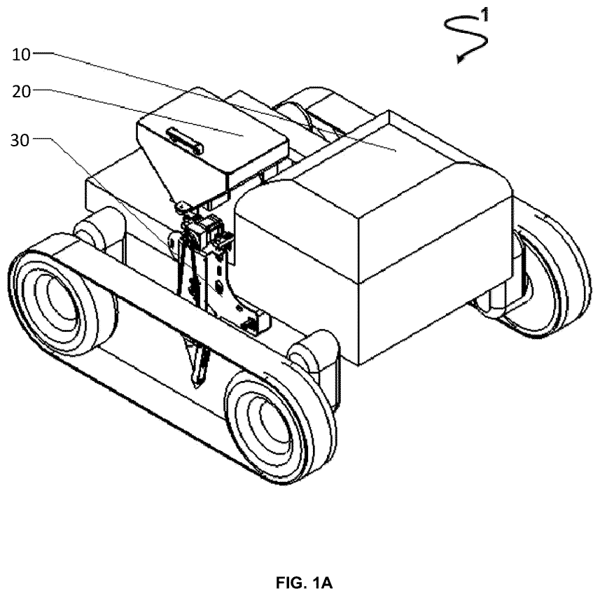

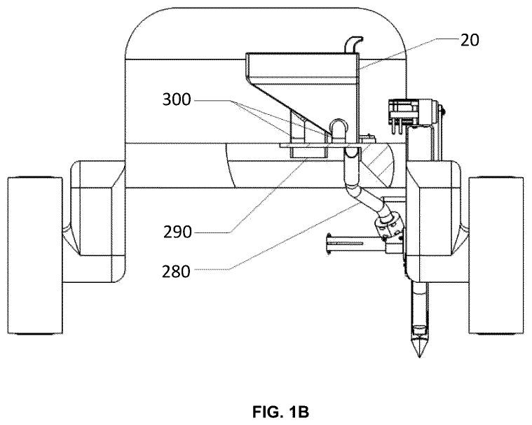

FIGS. 1A and 1B show a perspective view and a back view, respectively, of a planting system 1 according to a non-limiting exemplary embodiment of the invention. Planting system 1 in the current embodiment is shown to have a planting apparatus 30, coupled to a hopper 20 for housing seedballs. Hopper 20 and planting apparatus 30 are mounted on vehicle 10. In some embodiments, vehicle 10 may be an unmanned Ground Vehicle (UGV). In other embodiments, vehicle 10 may be a manned ground vehicle or any other moving platform known in the field.

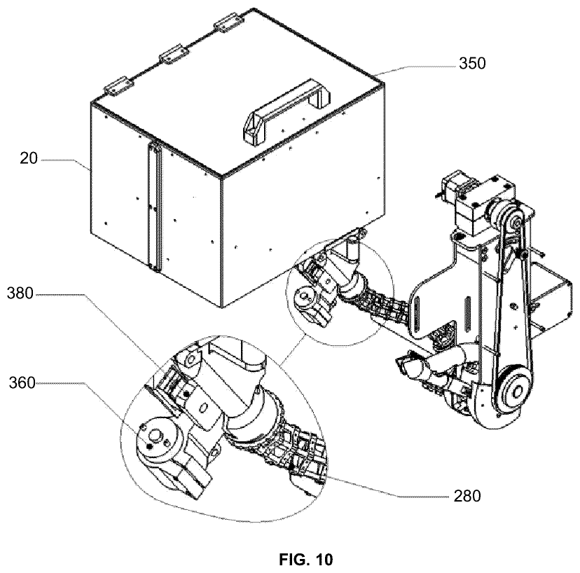

Hopper 20 may have different sizes and shapes known in the field, dependent on the volume of the hopper and the amount of seedballs required to be contained within the hopper. In the exemplary embodiment shown in FIGS. 1A and 1B, hopper 20 is shown to be coupled to planting apparatus 30 by a pipe 280, which is configured and functions to deliver seedballs from hopper 20 to the planting apparatus 30. Pipe 280 is configured to allow for receiving and passing one seedball from hopper 20 to the receiving opening of planting apparatus 30. As such, the diameter of the pipe 280 is configured to be at least slightly larger than the diameter of the seedball. The orientation of pipe 280 is shown to allow for the seedball 240 to utilize gravity when moving from hopper 20 to the receiving opening of planting apparatus 30. Hopper 20 is shown to be mounted to the frame of vehicle 10 using shock absorbers 300 and equipped with vibration motor 360 (see FIG. 10), which may be used to prevent seedballs from being stuck or jammed at the connection point between hopper 20 and pipe 280.

The wheelbase of vehicle 10 is shown in FIGS. 1A and 1B to be wider than the planting path of the planting apparatus 30 that is mounted on vehicle 10. Such design allows for minimal disturbance by the wheels of vehicle 10 to the soil path, in which the seedballs are indented to be planted.

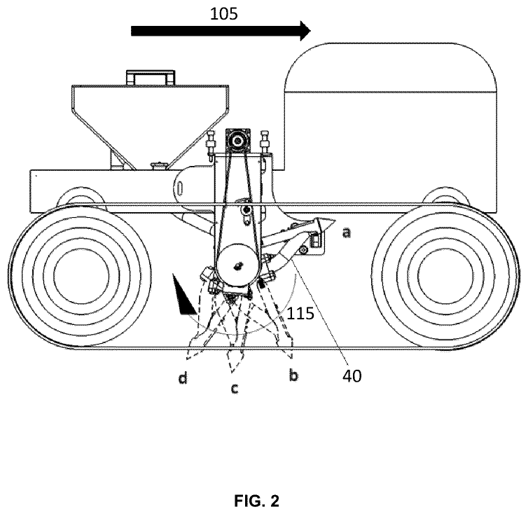

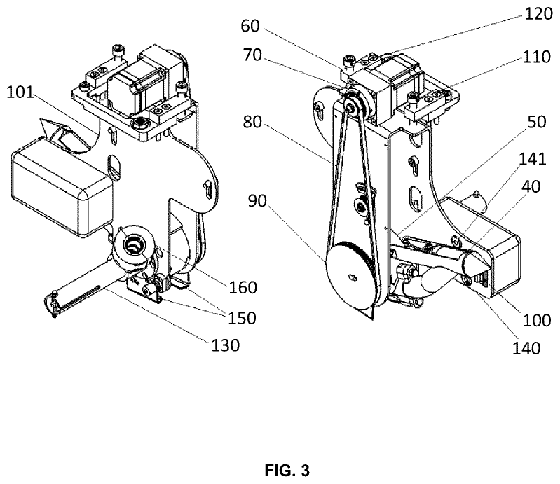

Referring to FIGS. 2 and 3, FIG. 2 shows a schematic side view of the planting system 1 of FIG. 1A in operation. FIG. 3 shows front and back perspective views of the planting apparatus 30 according to an embodiment of the invention. In FIG. 2, Arrow 105 represents the direction of movement of vehicle 10. The dotted lines represent different positions of the stinger 40, designated as positions a, b, c and d, each representing a different stage of the operational movement of the system, while vehicle 10 is moving. Stinger 40 is shown to move during the different stages of operation in a clockwise direction, represented by arrow 115, relative to a timing pully 90, which is part of the assembly of planting apparatus 30, and affixed to frame 101 of the assembly. The rotational direction of the movement path of the stinger 40 is in reference to the side view described and is not limited to being clockwise. In a different view, specifically the opposite side view of FIG. 2, the rotational movement of stinger 40 relative to timing pully 90 will be counterclockwise. It is intended that the rotational movement of the stinger be limited to either one of clockwise or counterclockwise. More specifically, the rotational direction of the stinger should be such that when the stinger touches the ground and penetrates the soil, the movement of the vehicle will cause the stinger to further penetrate the soil and continue its rotational movement.

The different positions of stinger 40 in FIG. 2 represent the different stages of planting during the operation of the system. In position a, representing the first stage, stinger 40 is shown to be in an idle position, substantially horizontal to the plane of the soil. The orientation of the stinger may vary in different embodiment but the head portion or tip 220 of the stinger 40 in position a will be away from the ground in a non-engaging position with the soil. In stage a, vehicle 10 is moved to the desired planting point. During stage a, stinger 40 is fixed in position by stopper 100 (shown in FIG. 3), positioned on frame 101. At position b, representing the second stage, stinger 40 has rotated to the point that tip 220 has started to penetrate the soil. Position c, representing the third stage, demonstrate the starting point of opening the shovels 210 of stinger 40, which causes tips 220 to start creating space in the soil for depositing seedball 240, which is released when stinger 40 achieves the deepest point under the soil surface. At position d, representing the fourth stage, after the seedball is planted in the soil, the stinger 40 continues to rotate exiting the soil and returning to the initial position a, where it is held in that position until vehicle 10 moves to the next planting location. The position of the next planting location may be ascertained by a Global Position System (GPS) that may be located in the vehicle. In other embodiments, the vehicle may be programmed with directions of predetermined locations based on the initial position. In other embodiments, the position of the next available location may be obtained either manually or remotely by a user.

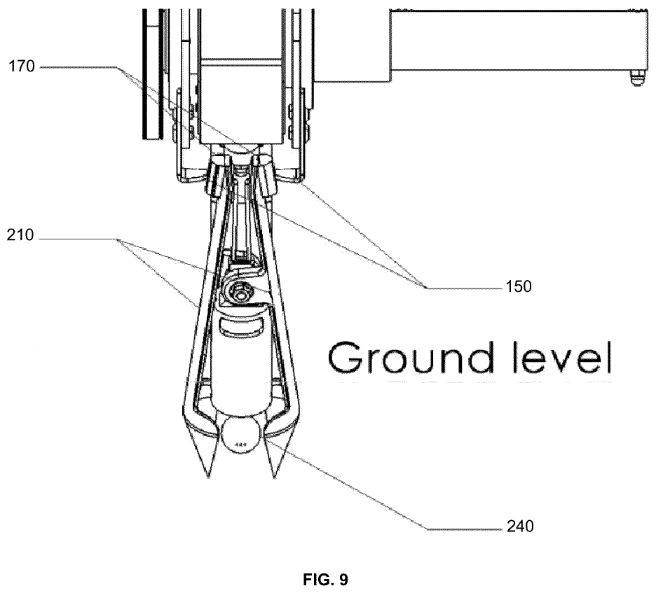

Details of the planting apparatus will be described in reference to FIGS. 1B to 9. FIG. 3 shows two perspective views of and exemplary embodiment of the planting apparatus 30. FIG. 3 shows a frame 101, on which different components of the planting apparatus are assembled. The receiving opening to planting apparatus 30 is configured to be couplable to pipe 280 and to receive seedball 240 that is disposed from hopper 20, through the pipe 280. The receiving opening leads to zone 160, in which seedball 240 is located before it is moved to unit 130, through which the seedball 240 is moved to the internal space 250 of the planting chamber 50 of planting apparatus 30. Zone 160 is equipped with sensors and actuators, which control the presence of seedball 240 in this area before it is moved to unit 130, which is coupled to frame 101. Different types of sensors known in the art may be used in zone 160 to control the presence of seedball 240 in that area. Non-limiting examples of such sensors include photosensors, IR sensors, ultrasonic sensors, proximity sensors, pressure sensors, etc.

Unit 130 is a chamber, the diameter of which is at least slightly wider than the diameter of the seedball 240. A pusher 230 is installed inside unit 130 and is configured to directly feed seedball 240, through unit 130, into internal space 250 of the planting chamber 50. In some embodiments, the sensors, upon detecting the seedball inside unit 130, the sensors will send a signal to pusher 230 to push the seedball inside channel 130 and move it to internal space 250 of the planting chamber 50. The pusher may be powered by its own independent power source or may be powered by power obtained from the planting apparatus or the vehicle. In some embodiments (not shown), tension springs may be used to actuate pusher 230. In some embodiments, planting apparatus 30 also comprises a system for screws that may be used for adjusting the high of frame 101, on which the planting apparatus is mounted, relative to the ground surface level. Different mechanisms, other than screws may be used in the system to adjust the height level of the planting apparatus 30 relative to the ground surface level.

FIG. 3 also shows an electric motor 60, which is used to rotate a unit 70, with one-way bearing 260, through which it transmits rotational motion to timing pulley 90 through belt 80 and rotates chamber 50 with stinger 40 that is joint with it. In FIG. 3, unit 70 and timing pulley 90 are shown to be affixed to frame 101 and chamber 50 with Stinger 40 joint to it are coupled to and rotated by the movement of the timing pulley 90. FIG. 3 further shows sensors 140 and 141 on frame 101, that control the position of the stinger 40 when it is held in idle position by stopper unit 100, and during its rotational movement to plan seeds or seedballs. The rotation of the stinger 40 is triggered by operation of motor 60 to move it from the idle position that is held by stopper 100. In some embodiments, sensors 140 and 141 are in electrical and/or data communication with motor 60. In such embodiments, when stinger 40 is detected by sensor 141, motor 60 is triggered to stop operation. In some embodiments, sensors 140 and 141 and motor 60 may also be in electrical and/or data communication with a processor, on which pre-determined planting location points is stored. When the vehicle is navigated, manually to automatically, to the next pre-determined location, the processor may trigger motor 60 to provide rotational movement to timing pulley 90 through unit 70 and belt 80, and sensors 140 and 141 may be triggers to release the stopper unit 100. In some embodiments, the sensors are powered by the same or different power source as motor 60. In some embodiments, the processor or control system may be present in the vehicle or may be exterior to the system and in a remote location.

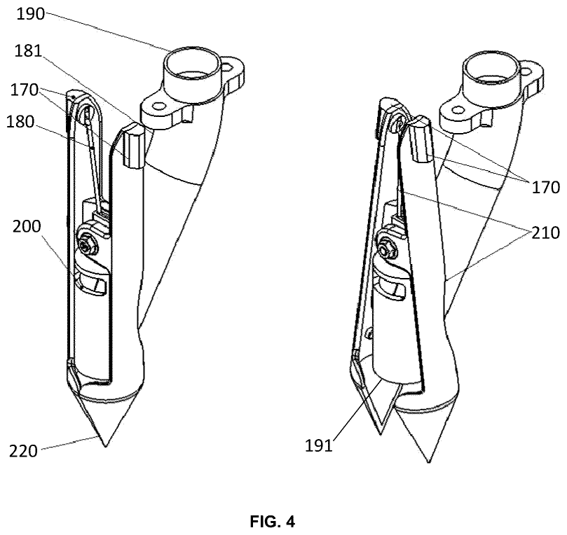

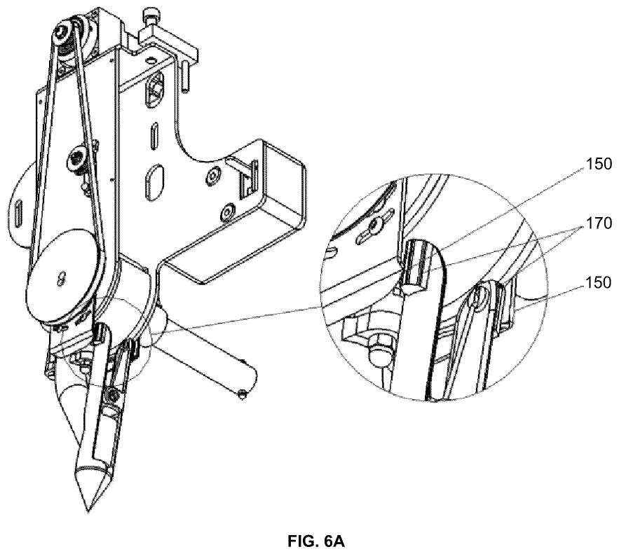

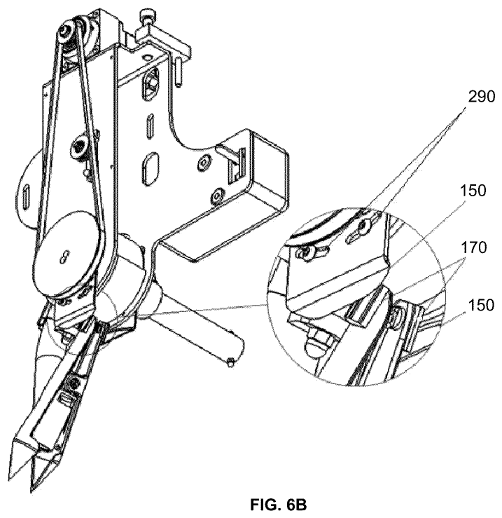

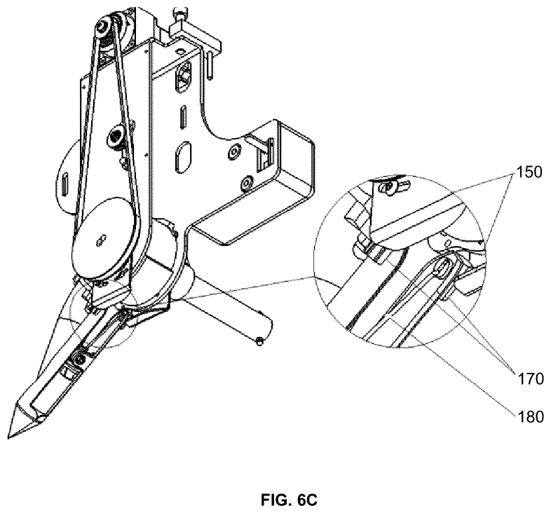

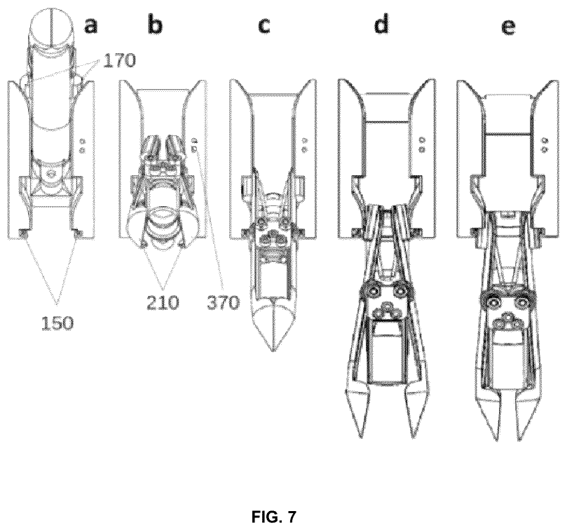

FIG. 4 shown the main elements of stinger 40, which comprises two parts. The first part is a channel, which starts with the area 190 and terminates at end 191. Area 190 is where seedballs 240 fall when stinger 40 rotates down to the ground from stopper unit 100. As such, the opening at area 190 is configured to be aligned with internal space 250 of planting chamber 50, where seedball 240 is positioned, while the stinger 40 is held by stopper 100 and is not in the substantially vertical position (i.e. the idle position far away from the ground). When motor 60 is operated to move stinger 40 in the substantially vertical orientation, then seedball 240 will fall due to gravity through the opening in area 190. Seedball 240 will then pass through channel 181 and end up in area 191. An opening 200 is provided in the first part near end 191 that allows for the removal of sand particles from channel 181 following the penetration cycle of the stinger 40 into the soil surface and while the stinger 40 is reset back to the stopper 100 position. The second part of stinger 40 is formed of two shovel arms 210 each terminating in a tip 220. Shovel arms 210 are coupled to one another and to the first part of stinger 40 so that shovel arms 210 move between a closed and an open configuration. In the closed configuration, tips 220 cover the opening of area 191 and obstruct movement of the seedball 240 past area 191. In the open configuration, tips 220 do not obstruct the downward movement path of seedball 240 past area 191. A clip spring 180 is coupled to each shovel arm 210 and is used to fix the shovel arms 210 in the closed configuration as the natural position. In other embodiments, different biasing mechanisms may be used. Any biasing means know in the art for such purpose may be used, including compression springs or torsion springs. Slips 170 are provided on the outer surface of each of shovel arms 210 to allow the shovel arms 210 to be manoeuvred to the open configuration, when slips 170 engage with and slide on special profiled parts 150 that are affixed to the bottom of frame 101, as will be described in detail below with reference to FIGS. 6A to 6C and FIG. 7.

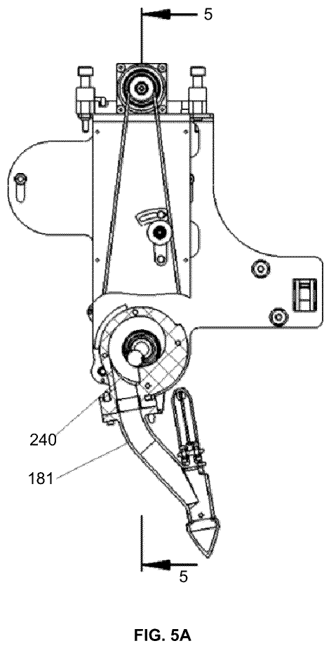

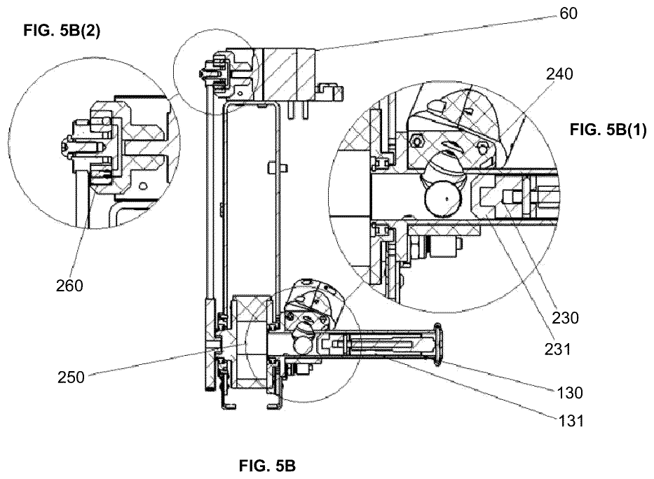

FIG. 5A shows the internal arrangement of chamber 50 and channel 181 of the first part of stinger 40, through which seedball 240 enters the internal space of the stinger 40 before planting. FIG. 5B shows a section taken along line 5-5 of FIG. 5A. The figure shows a pusher 230 installed inside unit or tube 130. In FIG. 5B(1), an enlarged view is provided, in which pusher 230 is shown to comprise a tip 231, which may be made from a soft material, such as silicone or other soft element material known in the art for similar use. The pusher 230 also includes an electric actuator 131 that directly pushes the seedball 240, when detected in tube 130, to the section leading to planting chamber 50. In FIG. 5B(2), an enlarged view is provided showing a sectional view of the bearing unit showing the installed one-way bearing 260.

A method of changing the configuration of the shovel arms 210 from the closed configuration to the open configuration during the process of planting seedballs is described with reference to FIGS. 6A, 6B and 6C, and the enlarged view in each of the figures. As described above, the mechanism described in the current embodiment that allows for moving the shovel arms 210 from the closed to the open configuration are based on clip springs and the use of protrusions (slips) 170 on the outer surface of the shovel arms 210 in combination with specially formed parts having surfaces that would dictate specific behaviour of the shovels 210 configuration when the slips are engaged with the specially profiled parts 150. In other embodiments, other mechanism known in the art may be used to achieve the same result. In the embodiment described in FIGS. 6A to 6C, the beginning of the process of opening shovel arms 210 is shown in FIG. 6A, when slips 170 come into contact with specially formed parts 150. FIG. 6B shows the moment when the shovels 210 are fully open. At this moment, the seedball 240 is penetrated to the required depth into the soil. With further movement of the stinger 40, the shovels 210 remain open, and the sand enters the gap between the shovels 210 and covers the seedball 240. FIG. 6C shows the moment when the stinger is completely out of the sand and the spring 180 closes the shovels 210 as the parts 150 are no longer in touch with slips 170.

FIG. 7 shows a bottom view of the planting device, which illustrates another embodiment, in which a variant shape of parts 150 is provided. Such variant facilitates cleaning of the planting device (both the stinger 40 and shovels 210). In FIG. 7, multiple positions are shown, each representing a different stage of operation over time. In position a, the slips 170 come into contact with parts 150 to start the process of shovels 210 opening as described above. In position b, when shovels 210 are opened and seedball 240 is deposited into the sand, slip 170 touches sensor 370. The sensor 370 may be a limit switch, a proximity sensor or other sensors known in the field that may achieve the same result. Once triggered, sensors 370 send a signal to the electrical motor, specifically stepper motor 60. When stepper motor 60 receives such signal, the motor is configured to start to rotate stinger 40 further, to remove it from the soil. Position c shows an intermediate position when the shovels 210 are closed abruptly after planting the seedball 240. The sudden closure of the shovels 210 is the direct result of the unique curvature of the parts 150 in relation to the slips 170 as the slips engage such curvature. During further rotation of the device, the shovels 210 open and then quickly close due to the force of spring 180, which is shown in positions d and e, respectively in FIG. 7. Such movement helps to clean stinger 40 and shovels 210 from sand particles. In other embodiments, the shape of parts 150 may be designed with different numbers of curves to allow for repeated movements of the shovels 210, which in turn leads to repeat movements of the stinger between the open and closed configurations and hence, more cleaning cycle within a single planting cycle.

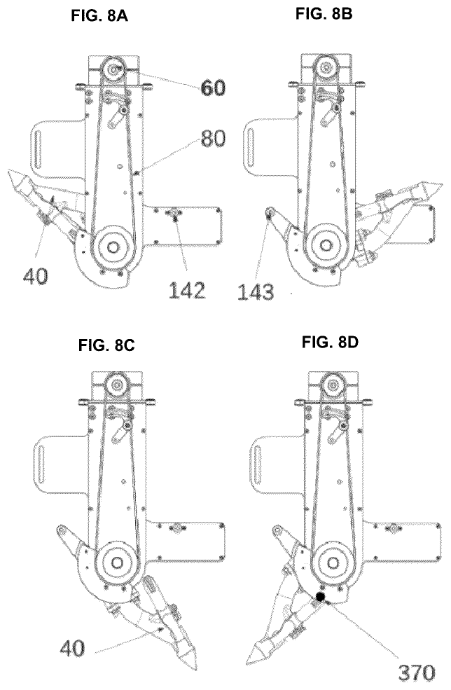

Different designs may be used to establish different embodiments of the invention. For example, the positioning of the sensors used to hold the stinger 40 in the idle position may be changed. FIG. 8A to 8D show a variant embodiment example of the planting device to operate stinger 40. In such embodiment, there are 2 sensors 142 and 143 provided. The sensors may be proximity sensors as a non-limiting example. Other sensors known in the field may be used. The sensors are used to control positions of the stinger 40 during operation over time. FIG. 8A shows the position of a stinger 40 in the idle position, which is held during the movement of vehicle 10 to the desired planting point. In such example embodiment, the orientation of the stinger 40 in the idle position is different from that provided in FIG. 3; however, Stinger 40 is still maintained far away from the ground with a non-engaging position between tip 220 and the surface of the ground. Stinger 40 is fixed because of the shape of parts 150, which is shown on FIG. 7 in position e, where stepper motor 60 is in a state to allow for holding the stinger 40 in that position. When vehicle 10 reaches the desired planting point, stepper motor 60 transmits the rotation by belt 80 with high speed until stinger 40 reaches sensor 142 which is shown in FIG. 8B. After that, stepper motor 60 is turned off and stinger 40 continues to rotate by inversion until it reaches the ground surface and gets moved inside soil by movement of the vehicle, which is shown in FIG. 8C. Thus, the process of the penetration of shovels 210 and stinger 40 into the soil and the planting occurs in this embodiment due to the movement of the vehicle 10, which is operated by its own power independent from motor 60 that operates stinger 40. In FIG. 8D, after reaching the sensor 370 located inside part 150, stepper motor 60 receives a signal from the sensor to starts applying rotational movement to timing pully 90 through belt 80, which triggers the steps described above for cleaning stinger 40 and shovels 210 and for putting stinger 40 into the initial, idle position. Once stinger 40 reach sensor 143, stepper motor 60 turns to holding mode and vehicle 10 is operated to proceed to the next desired planting point. In some embodiments, a processor or control system may be utilized to govern the actions of motor 60 in view of sensory data obtained from sensors 142 and 143. In other embodiments, the actions of motor 60 may configured to be reactionary to pre-determined sensor measurements by sensors 142 and 143 to automate the actions of motor 60 without the need to a processor or control system.

FIG. 10 shows a perspective view of an embodiment comprising a planting apparatus 30 connected to a hopper 20 through pipe 280, with an enlarged view provided at the connection point between the hopper and the pipe. Vibration motor 360 and movable part 380 are located at the bottom part of the hopper to prevent the jamming of seedballs in this area. Part 380 is jointed with servomotor which allows rotation of this part between 5 to 30 degrees counterclockwise (from the viewpoint provided in FIG. 10) to physically move the seedballs that are stuck and allow them to move down freely when part 380 comes back to its initial position. Vibration motor 360 may be used to generate vibration with different frequency depending on the weight and size of certain hopper models. Such movement causes a vibration in the connection between hopper 20 and pipe 280, which acts as the transition area for the seedballs from the hopper to the pipe. The vibration is such area allows for unjamming of any seedballs that get stuck in this area during their transition from the hopper to the pipe. In the event that seedballs are stuck in upper areas of the hopper, vibration motor 360 may also be used to vibrate the whole hopper as it is mounted on the frame of vehicle 10 using shock absorbers 300 (not shown in FIG. 10). In FIG. 10, hopper 20 has a transparent lid 350. Such optional feature allows for visual inspection of the interior of hopper 20, which in turn allows for determining the number of seedballs present inside the hopper without opening the hopper.

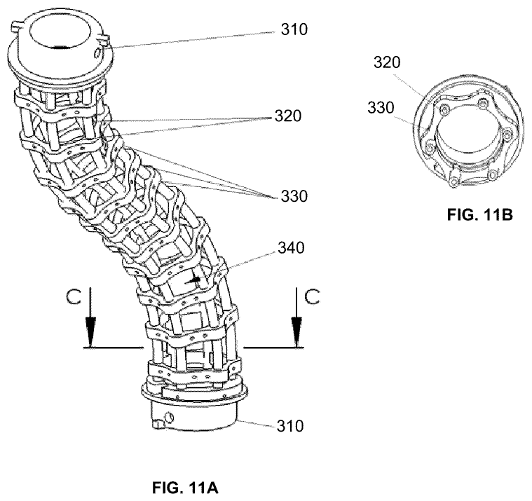

FIG. 11A shows a perspective view of pipe 280 which connects hopper 20 and planting device 30 in FIG. 10. Pipe 280 is shown to have ends 310, which act as joint parts to connect with each of hopper 20 and planting device 30, respectively. It is to be understood that the connection mechanism may be any known connection mechanism known in the field, including but not limited to screws, bolts, bayonet connection, or other mechanism. The main part of pipe 280 is shown to be made from longitudinal wires/pipes 320, which are flexible to allow for bending sections of pipe 280 while adjusting the height and/or orientation of the pipe to connect its ends 310 to hopper 20 and planting device 30. Wires/pipes 320 may be made from elastic plastic, silicone, metal wires, or other material known in the art, suitable for such function. The number of longitudinal wires 320 used may vary in different embodiments. In FIG. 11A, round links 330 are shown to be configured to be fixed on wires 320. FIG. 11B shows a cross-section view of part of FIG. 11A along lines C-C. In FIG. 11B, pipe 280 is shown to be formed of 6 longitudinal wires. The number of longitudinal wires, the diameter of such wires, the length of the longitudinal wires as well as the number of links 330 may vary in different embodiments based on the needed parameters of the pipe. The mesh structure of longitudinal wires 320 and links 330 creates a flexible pipe structure with a number of apertured 340 in its outer surface.

In use, seedball moves inside pipe 280 and predominantly touches longitudinal wires 320 during its movement due to the design shown in FIG. 11B. minimizing the surfaces of contact between the parts of pipe 280 and the seedball 240 during its movement inside the pipe allows for reducing resistance and friction during the movement of the seedball 240 inside pipe 280. Apertures 340 allow dust and small particles, that are the byproducts from movement of the seedball inside the pipe, to leave the internal space of pipe 280 and to fall from the pipe to the ground. This feature prevents debris from accumulating inside pipe 280 and reduces the amount of dust and particles, that may end up at pusher channel 130 and the internal space 250 of planting chamber 50. As such, apertures 340 allows for maintaining a smooth movement of seedballs inside pipe 280 without being jammed or stuck in the path of movement. Apertures 340 also help reduce jamming and malfunction at other parts of the planting apparatus, including the pusher channel 130 and the planting chamber 50. It should be noted that the apertures 340 should be smaller in size than the diameters of the seedball 240 to prevent seedball 240 from falling through apertures 340.

The current disclosure presents different designs for the planting device. Non-limiting examples of such designs are provided in FIG. 2 and in FIGS. 8A to 8D. It is worth noting that in the embodiments of the current invention, by limiting the rotational movement of the stinger 40 as described above, the combination of the rotational movement of the stinger 40, transmitted from the stepper motor 60, and the linear movement of the vehicle 10 causes the total linear velocity of the stinger tip 220 to be higher than the liner velocity of the vehicle 10, when the stinger is not touching the ground. The use of a one-way bearing 260, as shown in FIG. 5B, located on the bearing unit 60 ensures that the rotational movement is transmitted from drive motor 60 only in a clockwise direction, in the viewpoint in FIG. 5B, while the bearing is fixed. When tip 220 of stinger 40 touches the soil (sand), the movement of the vehicle causes tip 220 to deepen into the soil due to the linear speed of vehicle 10. At such stage, the linear speed of the vehicle 10 is higher than the linear speed of the stinger tip and the one-way bearing 260 becomes free and does not transmit any torque from the drive 60 that would hinder the movement of stinger 40. Thus, tip 220 of stinger 40 is fixed at the soil entry point and does not move relative to this point in the horizontal direction, while vehicle 10 continues to move forward and the process of opening the shovels 210 that are described in FIGS. 6A, 6B and 6C and FIG. 7 occurs. After the stinger 40 comes out of the sand as described in FIG. 6C, its speed relative to vehicle 10 begins to fall and the one-way bearing begins to transfer rotation forces from the drive 60, lifting the stinger 40 up further and continuing rotation of stinger assembly, until the stinger 40 reaches the sensor 141. A that position, the motor 60 receives the command to stop rotation and the stinger 40 is fixed in position by stopper unit 100. While stinger 40 is held by stopper unit 100, vehicle 10 proceeds to the next desired planting point, at that point, the engine 60 begins to rotate the stinger assembly to start the next planting circle.

It should be noted that in any case of stinger movement, according to any of the embodiments in the current disclosure, the process of deepening the stinger and opening the shovels is carried out due to the transfer of force from the forward movement of the vehicle, which in turn makes it possible to exclude the influence of slippage in the process of planting and allow the planting device to utilise the full power of the vehicle in penetrating into the soil. In such cases, due to the one-way bearing, that prevents counter forces, this method ensures the planting of seeds or seedballs directly at the entry point of the tip of the stinger without affecting the nearest areas. The tip of the stinger moves vertically down without deviation from the initial planting point, after touching the planting point and slight penetration, when the soil friction forces fix it in the soil and force from the movement of the vehicle begin to be transferred to further deepen the tip. Therefore, the techniques utilized in this disclosure overcomes two known disadvantages of the prior art. Specifically the current disclosure prevents the slippage effect during planting of seeds or seedballs as well allows for planting with minimal disturbance to the soil close to the planting area, which allows for planting in area where irrigation systems are already deployed without damaging such systems.

Referring back to FIG. 3, in an optional embodiment (not shown), the system for adjusting the height of planting device may be equipped with an additional motor to adjust the planting depth during the planting process. In some embodiments, the height adjustment may be applied manually or automatically. In some embodiments, the height adjustment may be applied in accordance with an algorithm that tracks the surface condition of the soil and applies the required adjustment to the height of the planting system accordingly to ensure that the seed or seedballs planted are planted at a maintained desired depth regardless of any change to the surface level of the soil at any planting point along the planting path.

In some embodiments, the rotation speed of the stinger when descending from the stopper unit to the ground may be higher than the linear speed of movement of the vehicle. When the tip of the stinger in the planting device touches the ground, at that moment, an opposing force is applied to the tip and the speed of the stinger is changed to a lower one. By providing the one-way bearing described above, smooth operation of the assembly is ensured, thereby avoiding the commonly known slippage problem in the industry.

It is important to note that in the current disclosure, the planting mechanism is not mechanically associated with the driving wheels or other moving parts of the machine for the purpose of controlling the frequency and timing of the planting. Said differently, the planting mechanism is powered separately and independently from the power of the vehicle. This is observed given that the rotational movement of the stinger, when the stinger is not touching the ground, is described to be based on the power supplied by motor 60, which is independent from the motor of the vehicle. As such, the control of when the stinger is released from the stopper until is independent from the power of the vehicle. Due to such feature, it is possible to plant each seedball at different distances and the distance between the planting points can be significant, since for planting trees in many cases, it is required to have a distance of several metres. Also, depending on the landscape, the planting points may be unevenly distributed along the line of movement of the vehicle, which is a result that can be achieved by the above-mentioned feature. Further, when planting for recreational purposes, for example afforestation, some of the requirements could be to plant in natural manner of trees distribution, in this case distance between trees may be made variable in random order according to preprogrammed algorithm. Such feature provides a significant advantage of the current invention over the planting systems known in the prior art, in which the planting apparatus is directly or indirectly connected with the wheels of the vehicle, chains or some other parts of the vehicle's power system, which in turn makes it impossible to plant at different distances, i.e. variable planting distances between the planting points along the planting path. The current invention is distinguished over the prior because while the planting device uses the power of the vehicle by allowing the tip of the stinger to penetrate the soil due to the movement of the vehicle, the system allows for planting seedballs at any distance between points since the control of holding and releasing the stinger above ground is independent from the vehicle's power.

Referring back to FIGS. 2, 5A and 6A to 6C, it is important to note that the blades of shovels 210 open perpendicular or substantially perpendicular to the direction of movement of the vehicle. Since the stinger during planting rotates at a certain angle relative to the axis of rotation, this design makes it easier to fill the sand between the shovels to cover the seedball. As shown in FIG. 2 in c and d, it should be noted that at the moment of the beginning of the opening of the blades, the stinger is already located at an angle relative to the vertical axis and is moved further than the projection line of the axis, which allows, when opening the blades, to have a certain amount of soil above, which facilitates covering the seedballs with loosen soil. The starting angle of the opening of the shovels 210 may be changed due to the design of the specially profiled parts 150, since these parts can be displaced along the grooves 290 in the frame, as shown in FIG. 6B. Also, this method of opening the shovels allows planting of seedballs at a higher speed since after opening, the seedball remains in the central area between the shovels and does not have any obstacles along the direction of movement of the vehicle. Also, the shovels do not interfere with this direction and do not affect the seedball position in any way.

Throughout the disclosure, when reference is made to a motor receiving a signal to start or stop operation, it is to be understood that such signal may be communicated through electrical and/or data communication. It is to also be understood that in some embodiments, the operation of the start-stop signal may be designed as a switch mechanism, where no control systems are required to govern the operation of the motor. In other embodiments, control system may be used to govern the action required based on the signals received from the sensors. In such embodiment, a processor may be utilized to receive and store the signals from the sensors and to trigger an operational step of the motors to vary the status of the motor. Such control systems may be manually operated by a user or automatically controlled though the use or an algorithm that may be stored as a series of instruction on the processor.

Thus, in accordance with the system and method described in the present invention, the invention disclosed according to the different embodiments advantageously provides a portable seed or seedball planting system, that may facilitate planting seeds or seedballs at predetermined depths and predetermined planting locations with speed, accuracy, and without slippage. The distance between planting points may be different. The height of the planting system many be varied manually or automatically. The system also allows for planting with minimal disturbance to the area surrounding the planting point. Such feature allows the use of such system in areas where irrigation systems are installed. The system also does not require additional elements to cover the seedballs after planting as such function is performed using the shovels of the stinger in the system.

### Interpretation of Terms

Unless the context clearly requires otherwise, throughout the description and the claims:
“comprise,” “comprising,” and the like are to be construed in an inclusive sense, as opposed to an exclusive or exhaustive sense; that is to say, in the sense of “including, but not limited to”.
“connected,” “coupled,” or any variant thereof, means any connection or coupling, either direct or indirect, between two or more elements; the coupling or connection between the elements can be physical, logical, or a combination thereof.
“herein,” “above,” “below,” and words of similar import, when used to describe this specification shall refer to this specification as a whole and not to any particular portions of this specification.
“or,” in reference to a list of two or more items, covers all of the following interpretations of the word: any of the items in the list, all of the items in the list, and any combination of the items in the list.
the singular forms “a”, “an” and “the” also include the meaning of any appropriate plural forms.
“power source” and “power supply” refer to any source of electrical power in a form that is suitable for operating electronic circuits.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, “upper”, “lower”, “clockwise”, “counterclockwise” and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of device and method have been described herein for purposes of illustration. These are only examples. The technology provided herein can be applied to device and method other than the examples described above. Many alterations, modifications, additions, omissions and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

What is claimed is:

1. A planting system comprising:
a stinger configured to create an opening in the ground, deposit a seedball in the opening and to cover the seedball after its deposit, the stinger comprising:
a first part comprising a solid hollow channel disposed between a first end and a second end, the first end, the hollow channel and the second end forming a path of unobstructed fall movement of the seedball from the first end to the second end;
a second part comprising a pair of shovels, each of the pair of shovels having an arm and a tip, the arms are coupled to one another and to a section of the first part near the second end forming a pivoting point, wherein the arms are pivotally movable about the pivoting point to form one of a closed configuration and an open configuration, wherein in the closed configuration, the tips of the pair of shovels form a complementing shape to cover and block the path of the second end, and in the open configuration, the tips depart from each other to uncover and clear the path of the second end; and
a rotating platform, to which the stinger is securely coupled and is rotatable in a vertical plane, with the tips of the pair of shovels pointing away from the rotating platform;
wherein the stinger is configured to receive the seedball at the first end, rotate the tips in the closed configuration to penetrate the ground and create the opening in the ground, switch to the open configuration to deposit the seedball into the opening through the second end and continue rotating to exit the ground and to the cover the deposited seedball with soil from the ground.

2. The planting system according to claim 1, wherein the stinger further comprises biasing means coupled to each arm for maintaining the coupled arms in the closed configuration, wherein the stinger is configured to switch to the open configuration when external pressure is applied to the biasing means.

3. The planting system according to claim 2, wherein the rotating platform is coupled to a pulley that is rotated through a belt by a motor, wherein the pulley and the motor are fixed to a frame and wherein rotation movement of the pulley and the stinger are directly related.

4. The planting system according to claim 3, the planting system further comprising a tube having:
an end coupled to the first end of the stinger;
an opening in the tube for receiving the seedball; and
a pusher for sliding inside the tube to push the seedball inside the tube to the first end of the stinger.

5. The planting system according to claim 4, the planting system further comprising sensors disposed on the frame along the rotating path of the stinger, the sensors are configured to detect the stinger and the motor is configured to control the movement of the stinger based on data received from the sensors.

6. The planting system according to claim 5, wherein the planting system further comprises a stopper unit disposed on the frame along the path of movement of the stinger, wherein the stopper is configured to hold the stinger in an idle position based on data obtained from the sensors.

7. The planting system according to claim 6, wherein the frame is mounted on a vehicle.

8. The planting system according to claim 7, wherein the planting system further comprises a hopper for housing seedballs, the hopper is mounted on the vehicle and is connected to the receiving end of the tube by a flexible pipe, wherein the flexible pipe is configured to form a channel for the seedballs to fall from the hopper to the receiving end of the tube.

9. The planting system according to claim 8, wherein the height of the frame is adjustable relative to the vehicle and wherein the height of the frame directly correlates to a ground penetration depth of the stinger.

10. The planting system according to claim 9, wherein the motor comprises a one-way bearing and wherein the rotation of the stinger is locked in one of a clockwise or counterclockwise direction, such that when the tips of the stinger touch the ground and penetrate the soil, movement of the vehicle will cause the stinger to further penetrate the soil and continue rotating in the rotation direction.

11. The planting system according to claim 10, wherein when the stinger tips are in contact with the ground, the rotation movement of the stinger is based on forward movement of the vehicle and when the stinger tips are away from the ground, the rotational movement of the stinger is based on the motor.

12. The planting system according to claim 3, wherein each arm of the pair of shovels has a protrusion on its outer surface and wherein special profile parts are affixed to the bottom of the frame, such that during the rotational movement of the stinger, the stinger is configured to switch to the open configuration when the protrusions connect with and slide on the special profile parts.

13. The planting system according to claim 12, wherein planting system is configured such that the protrusions connect with and slide on the special profile parts during the rotation movement of the stinger when the tips are in contact with the ground.

14. The planting system according to claim 7, wherein the flexible pipe is a mesh-like structure formed by coupling a plurality of longitudinal wires to the internal circumference of a plurality of links to form a perforated channel.

15. The planting system of claim 12, wherein the hopper is mounted on the vehicle using shock absorbers.

16. The planting system of claim 15, wherein the hopper is equipped with a vibration motor for preventing seedballs from being jammed at a connection point between the hopper and the flexible pipe.

17. A method of using the planting system of claim 12 for accurately planting seedballs at predetermined planting locations and at predetermined soil depths, while in continuous motion, free of slippage, the method comprising:
configuring the planting system such that the mechanical operation of the motor is independent from the mechanical operation of the vehicle;
associating the rotational movement of the stinger with the motor, when the tips of the stinger are away from the ground and associating the rotational movement of the stinger with the forward movement of the vehicle, when the tips of the stinger are in contact with the ground; and
varying the height of the planting system in relation to the ground based on sensory information obtained about the ground.

18. The method according to claim 17, the method further comprising varying a distance between the predetermined planting locations by holding the stinger in a position away from the ground while moving the vehicle from one predetermined planting location to another predetermined planting location.

19. A method of planting seedballs using the planting system in of claim 12, while the vehicle of the planting system is in continuous movement, the method comprises:
(a) holding the stinger in an initial position away from the ground using the stopper unit;
(b) moving the vehicle to a desired planting location;
(c) rotating the stinger using the motor to a position, where the tips contact the ground;
(d) creating an opening in the ground using the stinger in the open configuration;
(e) depositing the seedball in the opening;
(f) continuing to rotate the stinger using the continuous movement of the vehicle to cover the seedball and exit the ground;
(g) operating the stinger using the motor to return and hold the stinger to the initial position; and
(h) repeating steps (b) to (g) until all desired planting locations are completed.
